(19) United States
(12) Patent Application Publication
(10) Pub. No.: US 2008/0125872 A1
(43) Pub. Date: May 29, 2008

(54) Control System

(76) Inventor: Rui-Guang Chen, Taipei (TW)

Correspondence Address: LAW OFFICES OF LAI AND ASSOCIATES, P.C., 5800 RANCHESTER STE 200, HOUSTON, TX, 77036, US

(21) Appl. No.: 11/461,675

(22) Filed: Aug. 1, 2006

(51) Int. Cl. G05B 15/02

(52) U.S. Cl. 700/1; 700/79

(57) ABSTRACT

A control system is disclosed. The control system is applied in a computer. This system comprises a signal generating module, a signal receiving unit and a processing unit. The signal generating module is for sending a signal to the computer. The signal receiving unit is disposed on the computer for receiving a signal. The processing unit is disposed in the computer to reduce or shut down an interference source generated by the computer based on the signal received by the signal receiving unit. Accordingly, noise is therefore reduced, and the computer is efficiently hidden.

### FIELD OF THE INVENTION

The present invention generally relates to a control system, and more specifically relates to the control system for use in a computer

### BACKGROUND OF THE INVENTION

Different interference sources would be generated while operating a computer. However, under specific environments, light sources, sounds or radio waves generated by the computer may interfere with or endanger a user/other people. For example, sounds or lights generated by military portable computers in a battle field would expose bases and people to enemies to cause serious damages and casualties. Alternatively the lights and noise generated by portable equipment in a hospital would interfere with patients during physical examinations. Hence, controlling the sounds, the light sources and the radio waves is an important issue on designing the computer.

To overcome the foregoing shortcomings, the inventor of the present invention based on years of experience in the related field and through extensive research and experiments, invents a control system for use in a computer as a method or a basis for achieving the aforementioned objective.

### SUMMARY OF THE INVENTION

Therefore, it is a primary objective of the present invention to provide a control system for use in a computer. The control system comprises a signal generating module, a signal receiving unit and a processing unit. The signal generating module is for sending a signal to the computer. The signal generating module is preferably a remote controller or at least one key. The key is disposed on the computer. The signal is transmitted through a transmission protocol. The key is preferably a hot key, a combination of at least one key or an additional button. The signal receiving unit is disposed in the computer for receiving the signal. The processing unit is preferably a central processor disposed in the computer to reduce or shut down an interference source generated from the computer based on the signal received by the signal receiving unit. The interference source can be a light source, a sound and a radio signal. The light source is preferably an indicator light from a light emitting diode (LED) or a display light from a backlight module. The sound is preferably generated from a speaker, a buzzer, and is a noise generated from a heat dissipation fan. In addition, reducing the interference source generated by the computer is to reduce the intensity or frequency of the interference source so as to avoid being detected by enemies, and the computer can work normally. Thus, by utilizing the system, the interference source generated by the computer is therefore reduced or shut down. The computer is efficiently hidden.

To make it easier for our examiner to understand the objective of the invention, its innovative features and performance, a detailed description and technical characteristics of the present invention are described together with the drawings as follows.

### BRIEF DESCRIPTION OF THE DRAWINGS

FIG. 1 is a schematic diagram of a computer of the present invention;

FIG. 2 is a schematic diagram of a control system according to an embodiment of the present invention;

FIG. 3 is a schematic diagram of a control system according to another embodiment of the present invention;

FIG. 4 is a schematic diagram of a control system according to a further embodiment of the present invention;

FIG. 5 is a schematic diagram of a control system according to an additional embodiment of the present invention;

FIG. 6 is a flowchart of a control method of a control system according am embodiment of the present invention;

FIG. 7 is a flowchart of a control method of a control system according to another embodiment of the present invention;

FIG. 8 is a flowchart of an interference source generated by the computer is shut down; and

FIG. 9 is a flowchart of the interference source generated by the computer is reduced.

### DETAILED DESCRIPTION OF THE PREFERRED EMBODIMENTS

Referring to the related figures for the control system according to a preferred embodiment of the present invention, wherein the same elements are described by the same reference numerals.

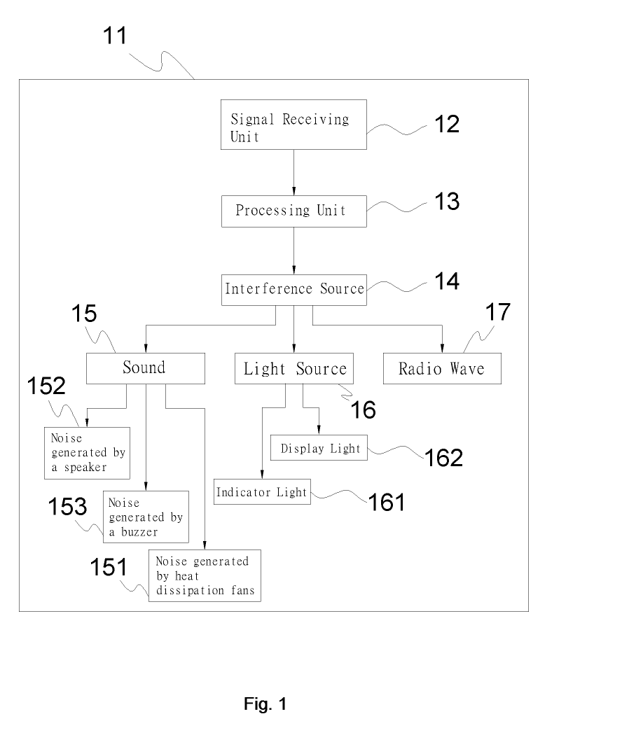

Referring to FIG. 1, a block diagram of a computer of the invention is illustrated. The computer 11 includes a signal receiving unit 12 and a processing unit 13. The signal receiving unit 12 is for receiving a signal sent by a signal generating module. The signal is then transmitted by the processing unit 13. An interference source 14 generated by the computer is then reduced or shut down. In addition, the interference source 14 generated by the computer includes a sound 15, a light source 16, and a radio wave 17. The sound is preferably generated by a speaker 152, a buzzer 153 and a noise from a heat dissipation fan 151. The light source is preferably an indicator light 161 and a display light 162.

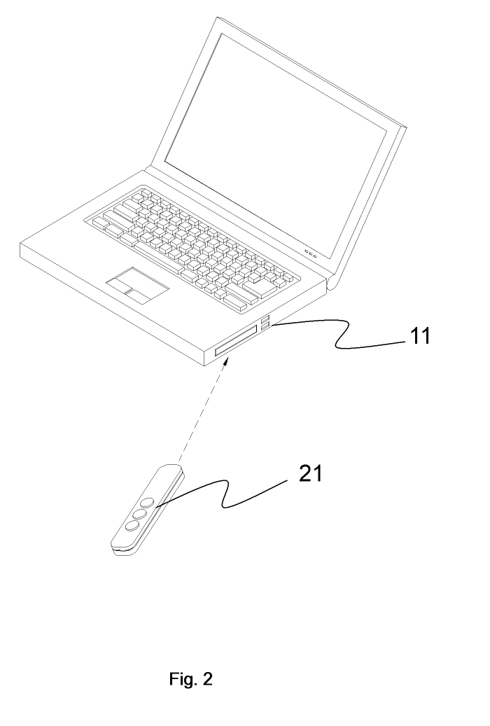

Referring to FIG. 2, a schematic diagram illustrates a control system according to an embodiment of the present invention. The control system includes a signal generating module 21 as the remote controller and a computer 11 as the notebook computer. A signal is generated by the signal generating module 21. The signal is then transmitted to the computer 11 to reduce or shut down an interference source generated by the computer.

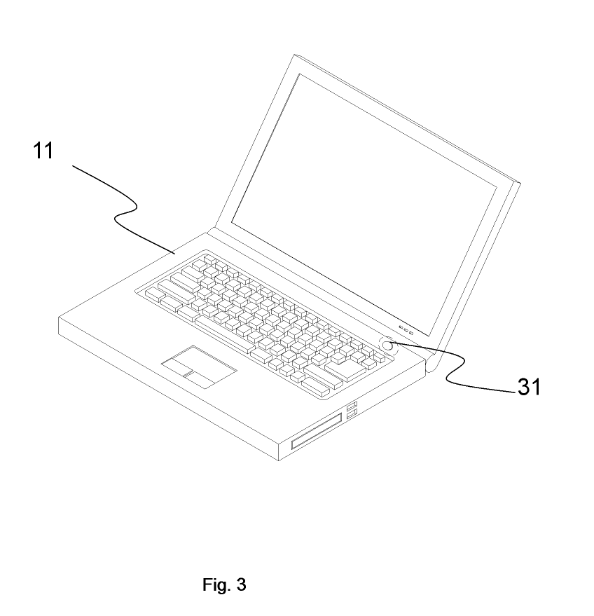

Referring to FIG. 3, a schematic diagram illustrates a control system according to another embodiment of the present invention. The control system comprises a signal generating module 31 as hot keys disposed on the computer and the computer 11 as the notebook computer. A signal is generated by the signal generating module 31. The signal is then transmitted to the computer 11 to reduce or shut down an interference source generated by the computer.

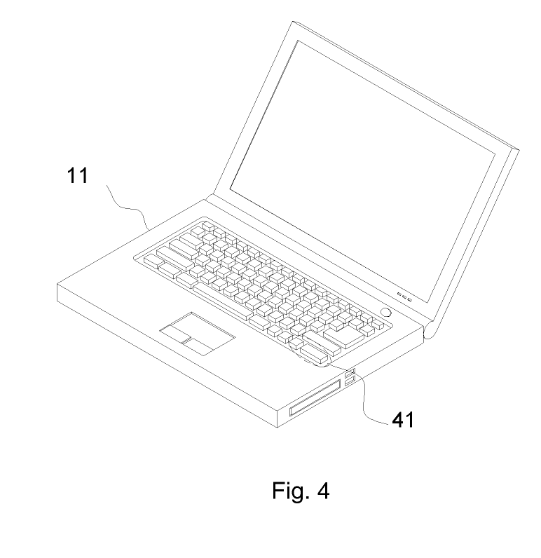

Referring to FIG. 4, a schematic diagram illustrates a control system according to a further embodiment of the present invention. The control system comprises the computer 11 as the notebook computer and a combination of as at least one key as a signal generating module 41. A signal is generated by the signal generating module 41. The signal is then transmitted to the computer 11 to reduce or shut down an interference source generated by the computer.

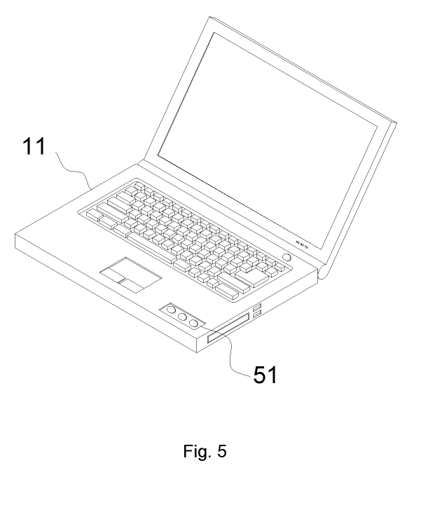

Referring to FIG. 5, a schematic diagram illustrates a control system according to an additional embodiment of the present invention. The control system comprises the computer 11 as the notebook computer and an additional button as a signal generating module 51. A signal is generated by the signal generating module 51. The signal is then transmitted to the computer 11 to reduce or shut down an interference source generated by the computer.

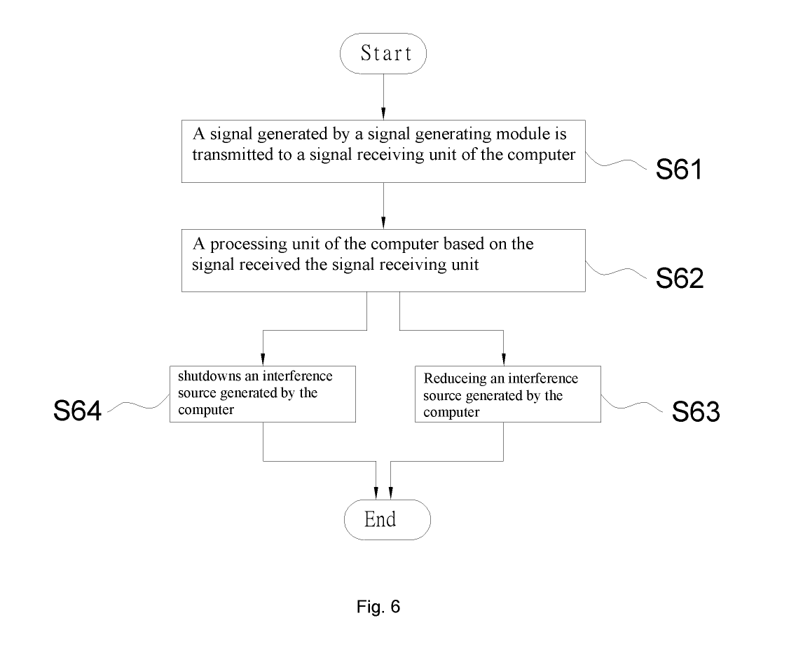

Referring to FIG. 6, a flowchart illustrates a control method of a control system according to an embodiment of the present invention. The method is applied in a computer. When the computer is in power-on, the control method comprises the following steps: A signal generated by a signal generating module is transmitted to a signal receiving unit of the computer S61. A processing unit of the computer based on the signal received the signal receiving unit S62 reduces an interference source generated by the computer S63 or shuts downs an interference source generated by the computer S64. In addition, a transmission protocol is provided to transmit the signal. A remote controller is provided to be the signal generating module. A hot key, a combination of at least one key and an additional button are provided to be the signal generating module. A central processor is provided to be the processing unit.

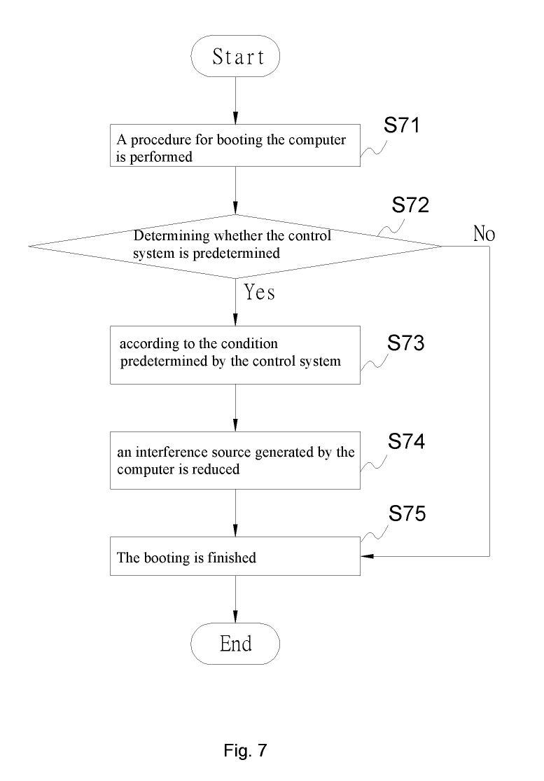

Referring to FIG. 7, a flowchart illustrates another control method of a control system according to another embodiment of the present invention. The method is applied in the computer. When the computer is in power-on, the control method comprises the following steps: A procedure for booting the computer is performed S71. Determining whether the control system is predetermined S72, if yes, according to the condition predetermined by the control system S73, an interference source generated by the computer is reduced S74. The booting is then finished S75. If not, the booting is directly finished S75. In addition, by making a schedule or by predetermining an extra condition, an interference source generated by the computer is reduced or shut down.

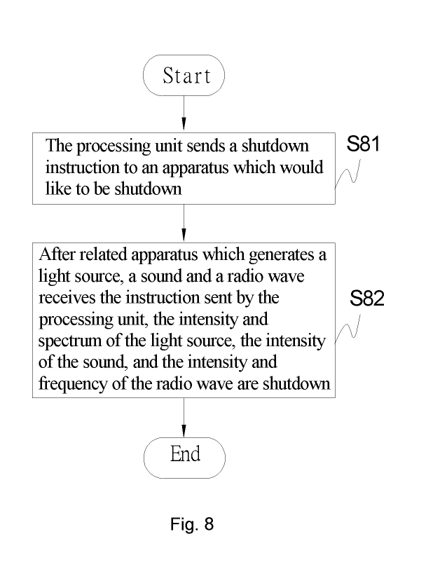

Referring to FIG. 8, a control flowchart of an interference source generated by the computer is shut down. The procedure comprises the following steps: The processing unit sends a shutdown instruction to an apparatus which would like to be shut down S81. After related apparatus which generates a light source, a sound and a radio wave receives the instruction sent by the processing unit, the intensity and spectrum of the light source, the intensity of the sound, and the intensity and frequency of the radio wave are shut down S82. Lastly, the procedure is finished.

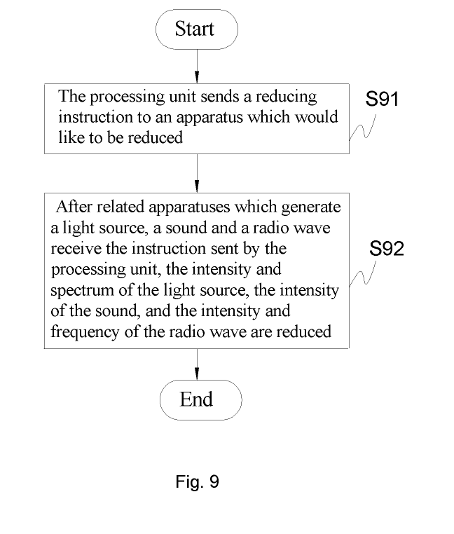

Referring to FIG. 9, a control flowchart of the interference source generated by the computer is reduced. The procedure comprises the following steps: The processing unit sends a reducing instruction to an apparatus which would like to be reduced S91. After related apparatuses which generate a light source, a sound and a radio wave receive the instruction sent by the processing unit, the intensity and spectrum of the light source, the intensity of the sound, and the intensity and frequency of the radio wave are reduced S92. Lastly, the procedure is finished.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A control system for use in a computer, comprising:
a signal generating module for sending a signal to said computer;
a signal receiving unit disposed in said computer, and for receiving said signal; and
a processing unit disposed in said computer, and for reducing or shutting down an interference source generated by said computer based on said signal received by said signal receiving unit.

2. The control system of claim 1, wherein said signal generating module is a remote controller.

3. The control system of claim 1, wherein said signal generating module is at least one hot key disposed on said computer.

4. The control system of claim 1, wherein said signal generating module is a combination of at least one key disposed on said computer.

5. The control system of claim 1, wherein said signal generating module is an additional button disposed on said computer.

6. The control system of claim 1, wherein said signal is transmitted through a transmission protocol.

7. The control system of claim 1, wherein said processing unit is a central processor.

8. The control system of clam 1, wherein said interference source is a light source.

9. The control system of claim 8, wherein said light source is an indicator light.

10. The control system of claim 9, wherein said indicator light is a light emitting diode (LED).

11. The control system of claim 8, wherein said light source is a display light.

12. The control system of claim 11, wherein said display light is a backlight module.

13. The control system of claim 1, wherein said interference source is a sound.

14. The control system of claim 13, wherein said sound is a noise generated from a heat dissipation fan.

15. The control system of claim 13, wherein said sound is generated from a speaker.

16. The control system of claim 13, wherein said sound is generated from a buzzer.

17. The control system of claim 1, wherein said interference source is a radio wave.
